(19) United States
(12) Patent Application Publication
(10) Pub. No.: US 2025/0164232 A1
(43) Pub. Date: May 22, 2025

(54) Measuring Device and Method for Determining an Angular Position Signal

(71) Applicant: TDK-Micronas GmbH, Freiburg i. Br (DE)

(72) Inventors: Nils Remmers, Schopfheim (DE); Timo Kaufmann, Emmendingen (DE)

(21) Appl. No.: 18/954,001

(22) Filed: Nov. 20, 2024

(30) Foreign Application Priority Data
Nov. 21, 2023 (DE) 10 2023 132 390.3

(51) Int. Cl. G01B 7/30

(52) U.S. Cl. CPC G01B 7/30

(57) ABSTRACT

A measurement apparatus has a magnet apparatus and a sensor apparatus, which can be rotated relative to one another about an axis of rotation. To generate magnetic field measurement signals, the sensor apparatus has a number of at least three magnetic field sensors, which are arranged offset from one another by an angle of rotation, each having an output to output a magnetic field measurement signal. The outputs are connected to a first signal path, in which a transformation device for transforming the magnetic field measurement signal into a plurality of phase-shifted transformation signals is arranged, which plurality is less than the number of the magnetic field sensors. Output connectors for the transformation signals are connected to an evaluation device for generating the angle position signal. A comparator is arranged in a further signal path and is connected to the measurement signal output of a magnetic field sensor, for comparing the magnetic field measurement signal of one of the magnetic field sensors with a comparator threshold value signal. For detecting a phase error, the evaluation device has a phase position comparison element, which has a first phase position comparison element input connected to an output connector of the transformation device, and a second phase position comparison element input connected to the comparator output.

### CROSS-REFERENCE TO RELATED APPLICATION

This application claims priority to German Patent Application No. 10 2023 132 390.3 filed Nov. 21, 2023, the disclosure of which is hereby incorporated by reference in its entirety.

### BACKGROUND OF THE INVENTION

### Field of the Invention

The invention relates to a measurement apparatus for determining an angle position signal, having a magnet apparatus and a sensor apparatus, which are mounted so as to rotate relative to one another about a geometrical axis of rotation, wherein the sensor apparatus has a number of at least three magnetic field sensors that are arranged to be offset from one another, with reference to the axis of rotation, in terms of the angle of rotation, to generate magnetic field measurement signals that are phase-shifted relative to one another, wherein the magnetic field sensors have measurement signal outputs to output the magnetic field measurement signals, wherein the sensor apparatus has a first signal path in which a transformation device for transforming the at least three magnetic field measurement signals into a plurality of phase-shifted transformation signals is arranged, which plurality is less than the number of the magnetic field sensors, wherein the measurement signal outputs of each magnetic field sensor are connected, in each instance, to an input of the transformation device, and the transformation device has an output connector for each transformation signal, in each instance, and wherein the output connectors are connected to an evaluation device by means of which the angle position signal can be generated as a function of the transformation signals, and can be output at an angle position signal output. Furthermore, the invention relates to a method for determining an angle position signal, using a magnet apparatus and a sensor apparatus, in which method the magnet apparatus and the sensor apparatus are mounted so as to rotate relative to one another, about an axis of rotation, wherein the sensor apparatus has a number of at least three magnetic field sensors that are arranged to be offset from one another, with reference to the axis of rotation, in terms of the angle of rotation, to generate magnetic field measurement signals that are phase-shifted relative to one another, wherein the magnetic field measurement signals are transformed into a plurality of phase-shifted transformation signals, which plurality is less than the number of the magnetic field sensors, and wherein the angle position signal is generated using the phase-shift signals obtained in this manner.

### DESCRIPTION OF RELATED ART

An apparatus and a measurement method of the type stated initially are known from DE 10 2014 109 693 A1. In the measurement method, a magnet apparatus and a sensor apparatus are made available, which are mounted so as to rotate relative to one another about a geometrical axis of rotation. The sensor apparatus has three magnetic field sensors, which are offset relative to one another, in terms of angle, with reference to the axis of rotation, in such a manner that the magnetic field sensors detect magnetic field measurement signals that are phase-shifted relative to one another by 120 degrees.

### SUMMARY OF THE INVENTION

Using a transformation, two output signals that are orthogonal to one another are calculated from the three output signals of the magnetic field sensors. In the case of a continuously rotating magnet apparatus, two harmonic oscillations (sin, cos), which are phase-shifted relative to one another by 90 degrees, occur for the output signals. From these two signals, i.e., from their instantaneous value, the angle position is then calculated directly in an evaluation device suitable for this purpose, by means of the arctangent function. The apparatus and the method are not restricted to three magnetic field sensors and primarily serve for compensating external magnetic interference fields, which occur, in particular, in the application environment of automobile electronics. As a result, a more precise measurement of the angle positions is made possible. The precision of the angle position signal is increased by means of the use of more than three magnetic field sensors.

Many sensor apparatuses also have the possibility of outputting the signals in a differential form, and devices for phase reversal (phase shift by 180°) are used for this purpose. There are also circuits that transpose sin and cos signals and thereby result in a jump of n*90° or change the direction. Such electronic circuits that influence the phase position of the two output signals [missing word] and can function incorrectly due to the external interference fields that have been explained or on the basis of other sources. In this regard, the external interference occurs either as homogeneous or gradient, static magnetic fields or in the form of transient or periodic alternating fields. The latter, specifically, might lead to malfunctions of the electronic circuits, while the former are more likely to distort the transmitter or reference magnetic field made available by the magnetic apparatus. The robustness of corresponding arrangements and the associated phenomena are generally summarized with the general term of electromagnetic compatibility (EMC). The formation of the arctangent function from the two orthogonal output signals (sin, cos) then leads to an incorrect result for the angle position, although the EMC-related interference introduction is already compensated directly in the utilization and measurement signals (distortion of the transmitter magnetic field) by means of the method known in the state of the art.

The task therefore exists of detecting an incorrect influence on the phase position, so as to recognize an incorrect calculation of the angle position in a timely manner. Vice versa, a correct influence on the phase position, which is necessary due to a zero point calibration, for example, increases the confidence level of the calculated angle position. In safety-related applications, as they exist in many areas of automotive technology, this task is a requirement.

This task is accomplished, with regard to the measurement apparatus of the type stated initially, in that the sensor apparatus has at least one further signal path in which a comparator is arranged, which is connected, for comparing the magnetic field measurement signal of one of the magnetic field sensors or a combination of the magnetic field measurement signals of multiple magnetic field sensors having a comparator threshold value signal, to the measurement signal output of at least one magnetic field sensor, and has a comparator output for output of a digital comparison value signal, that the evaluation device has a phase position comparison element having a first and a second phase position comparison element input for detecting a phase error, that the first phase position comparison element input is connected to the first output connector of the transformation device or the angle position signal output, and the second phase position comparison element input is connected to the comparator output, and the phase position comparison element has a phase position comparison element output for output of a phase position difference signal.

The comparator threshold value signal can be a non-differential or a differential comparator threshold value signal. At a voltage value of the output signal of the connected magnetic field sensor, established by means of the comparator threshold value signal, the digital comparator output switches either to the digital level HIGH (logic “1”) or LOW (logic “0”) if the comparator threshold value signal is exceeded or not reached. The digital comparison value signal formed in this way corresponds to a digital phase position signal. In this regard, it is a digital output signal, in the case of a continuously rotating relative movement between the magnet apparatus and sensor apparatus, which signal is periodic and the period duration or frequency of which represents the phase position of the output signal of the magnetic field sensor with reference to the absolute time. In the case of a rotation of the magnet apparatus at a constant speed relative to the sensor apparatus, the digital comparison value signal is a periodic signal having a constant frequency. In the case of a changing speed of the angle of rotation, the signal continues to be periodic, but the frequency is changeable, in accordance with the speed of the angle of rotation. The magnet apparatus can be firmly connected to the rotor of a drive, the angle position of which is supposed to be measured. In order to simplify the evaluation of the transformation signals, these are preferably arranged orthogonal to one another.

With reference to the method, the task mentioned above is accomplished in that the magnetic field measurement signal of at least one magnetic field sensor or a combination of the magnetic field measurement signals of multiple magnetic field sensors is compared with a threshold value signal, so as to generate a digital comparison value signal, and that to detect a phase error, the phase position of at least one transformation signal or the phase position of the angle position signal is compared with the phase position of the digital comparison value signal.

In an advantageous embodiment of the invention, the output connectors of the transformation device are indirectly connected to the evaluation device by way of a phase-shift device, wherein the phase-shift device has a phase-shifter output for each transformation signal, in each instance, for output of a phase-shifted transformation signal, in each instance, which signal is shifted by a predetermined phase angle as compared with the transformation signal in question, and wherein the phase-shifter outputs are connected to the evaluation device to generate the angle position signal. By means of the phase-shift device, a zero-point calibration of the angle position signal becomes possible, in a simple manner, when using the measurement apparatus, if the individual transformation signals are shifted by the same phase angle, in each instance. This is particularly advantageous in the case of measurement apparatuses in which the sensor apparatus is implemented from purely analog-electronic circuit blocks. It is also possible, however, to shift the first and second transformation signal by different phase angles, using the phase-shift device, so as to compensate errors in the phase position of the transformation signals relative to one another and, in particular, in the orthogonality of the transformation signals. If interference were to occur in the phase shift of the transformation signals, which interference influences the phase position, this can be determined by means of comparing the angle position signal with the flanks of the digital comparison value signal or by means of comparing at least one of the transformation signals that were phase-shifted using the phase-shift device, if applicable, with the flanks of the digital comparison value signal.

In a preferred embodiment of invention, the evaluation device has a phase position difference signal monitoring device, connected to the phase position comparison element output, for detecting a change in the phase position difference signal. If interference occurs in the first signal path, the first and/or second phase position difference signal changes, and this is monitored using the phase position difference signal monitoring device. In this way, a plausibility check of the first signal path opens up, and errors in the signal processing that influence the phase position of the output signals (e.g., sin, cos) can be detected. If a phase error is detected, it can be displayed, if necessary.

It is advantageous if the phase position difference signal monitoring device has a comparison device for comparing the change in the phase position difference signals with a tolerance band. The tolerance band is preferably selected in such a manner that small deviations, which neither [word missing: lead] to a malfunction nor impair safety during operation of the measurement apparatus, are not detected as errors by the comparison device.

In a typical embodiment of the sensor apparatus, the magnetic field sensors can be configured as Hall sensors, TMR sensors, GMR sensors or AMR sensors.

In a practical embodiment of the invention, the magnetic field sensors and the signal paths are implemented in a single cast IC housing, integrated monolithically or in a hybrid manner.

In an alternative embodiment, the magnetic field sensors and the signal paths are implemented discretely on a support.

According to a further development, the measurement apparatus has at least one modulation device, which has a first input, connected directly or indirectly by way of the phase-shift device, to one of the output connectors of the transformation device, and a second input, connected to the comparator output of the further signal path, as well as a modulation signal output, wherein the modulation signal output is connected to a demodulation device of the evaluation device, connected to the modulation device. An advantage of this further development lies in that the comparator signal that is present at the comparator output is transmitted together with the output signal of the transformation device or of the phase-shift device, for evaluation, as a constant component, for example, and the evaluation or the detection of a phase error can take place in an evaluation device that is separate from the measurement apparatus.

Alternatively, the measurement apparatus can have at least one operating current modulation device for the sensor apparatus, with the input of which the comparator output of the further signal path is connected, wherein the evaluation device is connected to an operating current demodulation device of the evaluation device assigned to the operating current modulation device. The advantage of this variant is that the digital comparison value signal can be transmitted to the evaluation device by means of modulation of the operating current, so as to carry out the evaluation or the detection of a phase error there.

It should be noted that all the signals of the sensor apparatus can be implemented both as differential and as absolute value signals having a fixed reference potential.

### BRIEF DESCRIPTION OF THE DRAWINGS

The terms Fig., Figs., Figure, and Figures are used interchangeably in the specification to refer to the corresponding figures in the drawings.

In the following, exemplary embodiments of the invention are explained in greater detail, using the drawing.

The figures show:

FIG. 1 a schematic overview representation of a measurement apparatus,

FIG. 2 a block schematic of a first exemplary embodiment of the measurement apparatus,

FIG. 3 a block schematic of a second exemplary embodiment of the measurement apparatus,

FIG. 4 a block schematic of a third exemplary embodiment of the measurement apparatus,

FIG. 5 a block schematic of a fourth exemplary embodiment of the measurement apparatus,

FIG. 6 a graphic representation of the two partial signals of a differential transformation signal, wherein the time t is plotted on the abscissa and the electrical voltage U is plotted on the ordinate,

FIG. 7 a graphic representation of a digital comparison value signal, wherein the time t is plotted on the abscissa and the electrical voltage U is plotted on the ordinate,

FIG. 8 a graphic representation of the two partial signals of a modulated differential transformation signal, wherein the time t is plotted on the abscissa and the electrical voltage U is plotted on the ordinate, and

FIG. 9 a block schematic of a fifth exemplary embodiment of the measurement apparatus.

### DESCRIPTION OF THE INVENTION

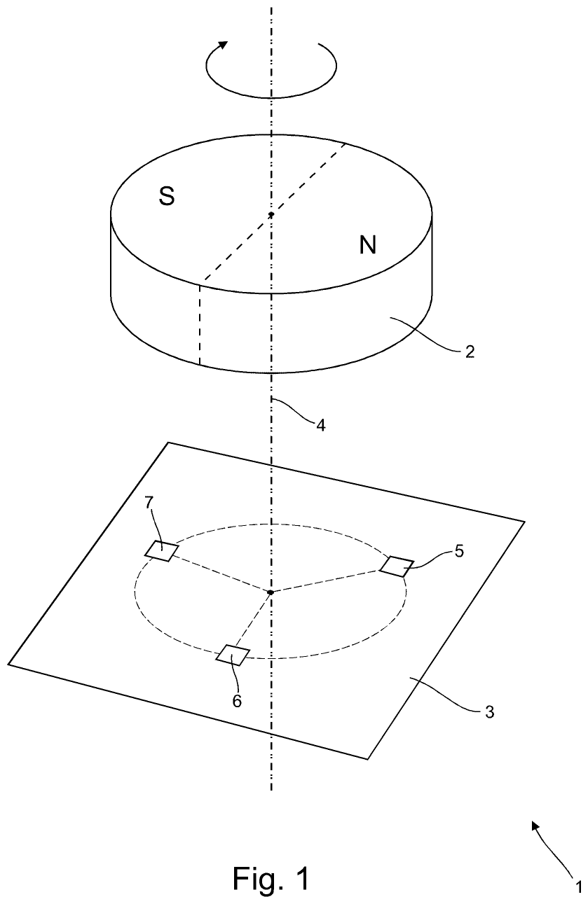

A measurement apparatus 1, indicated as a whole as 1 in FIG. 1, for determining an angle position signal, has a magnet apparatus 2 and a sensor apparatus 3, which are mounted so as to rotate relative to one another by means of a bearing not shown in any detail in the drawing, about an imaginary axis of rotation 4. The magnet apparatus 2 has a north pole N and a south pole S, which are offset from one another by 180° with reference to the axis of rotation 4. However, other embodiments are also conceivable, in which the north and south poles are offset from one another by angles other than 180°, in particular by unequal angles.

The sensor apparatus 3 has three magnetic field sensors 5, 6, 7 arranged on a semiconductor chip, which are arranged, with reference to the axis of rotation 4, at an angle distance of 120° relative to one another, in terms of the angle of rotation. However, other embodiments are also possible, in which the magnetic field sensors 5, 6, 7 are arranged at different angle distances relative to one another, offset in terms of their angle of rotation. In this way, harmonics in the angle position signal can be reduced.

The semiconductor chip is arranged with its plane of expanse orthogonal to the axis of rotation 4. The magnetic field sensors 5, 6, 7 are preferably situated on a circular path arranged concentric to the axis of rotation 4. When the magnet apparatus 2 is rotated about the axis of rotation 4 relative to the sensor apparatus 3, the magnetic field sensors 5, 6, 7 generate magnetic field measurement signals that are phase-shifted relative to one another. To output its magnetic field measurement signal, each magnetic field sensor 5, 6, 7 has a measurement signal output 8, 9, 10, in each instance.

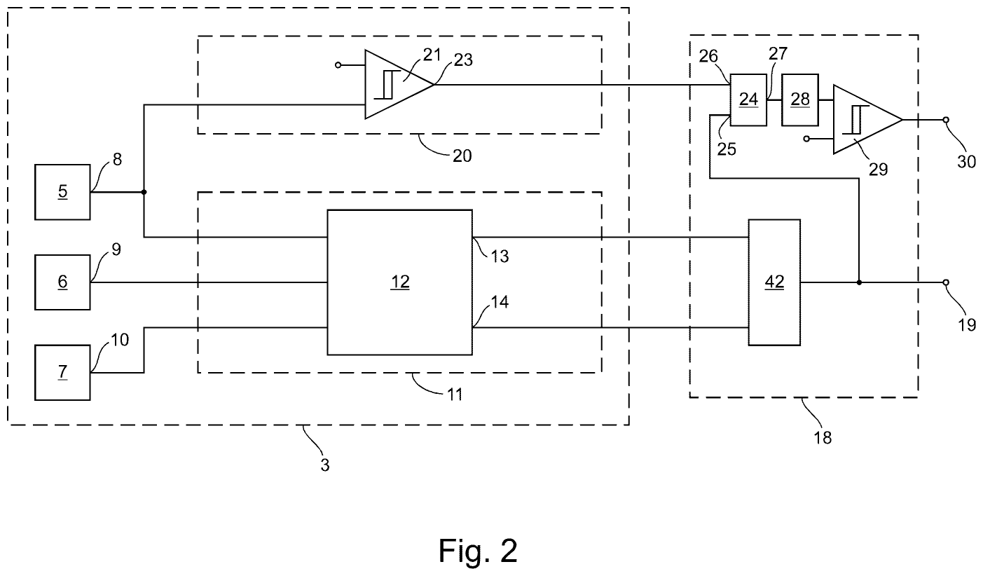

As can be seen in FIG. 2, the sensor apparatus 3 has a first signal path 11, on which a transformation device 12 for transforming the three magnetic field measurement signals into two transformation signals that are orthogonal to one another is arranged. The transformation device 12 has a first input connected to the measurement signal output 8 of a first magnetic field sensor 5, a second input connected to the measurement signal output 9 of a second magnetic field sensor 6, and a third input connected to the measurement signal output 10 of a third magnetic field sensor 7. The transformation device 12 is configured to carry out a Clarke transformation, which transforms the magnetic field measurement signals into a sine-shaped first transformation signal (real part) and a cosine-shaped second transformation signal (imaginary part). The first transformation signal can be output at a first output connector 13, and the second transformation signal can be output at a second output connector 14.

The first output connector 13 is connected to a first input of an evaluation device 18 and the second output connector 14 is connected to a second input of the evaluation device 18. Using the evaluation device 18, an angle position signal can be generated as a function of the first transformation signal that is present at the first output connector 13 and the second transformation signal that is present at the second output connector 14, which signal indicates the rotational position in which the magnet apparatus 2 is rotationally positioned about the axis of rotation 4, relative to the sensor apparatus 3. The angle position signal is determined in a computation device 42 of the evaluation device 18, by means of calculating the arctangent of the quotient of the first transformation signal and the second transformation signal. The angle position signal can be output at an angle position signal output 19 of the evaluation device 18.

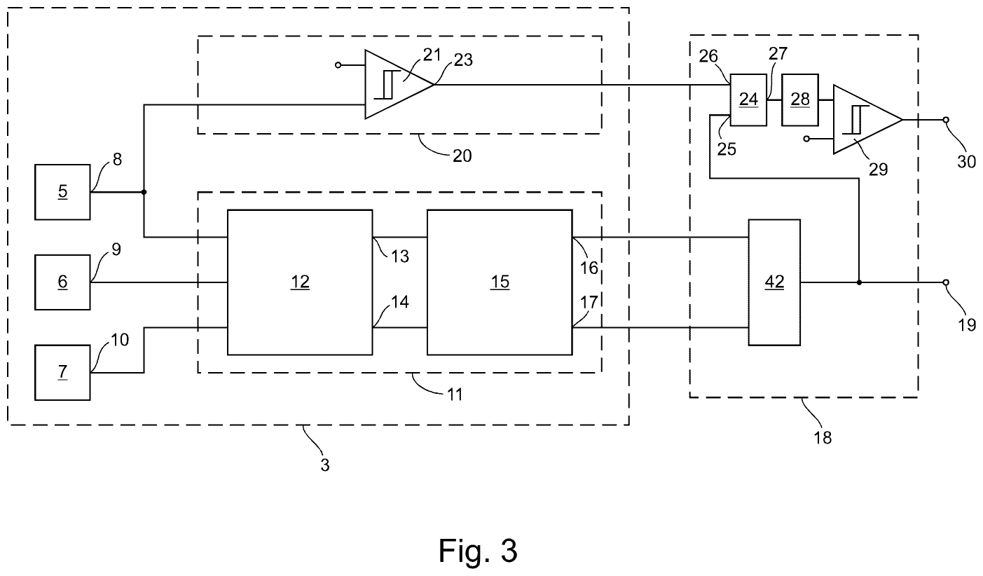

In the case of the exemplary embodiment shown in FIG. 3, a phase-shift device 15 is furthermore arranged on the first signal path 11, which device has a first phase-shifter input and a second phase-shifter input. The first phase-shifter input is connected to the first output connector 13 of the transformation device 12, and the second phase-shifter input is connected to the second output connector 14 of the transformation device 12. In this way, the zero point of the phase position can be calibrated. The first transformation signal, which is phase-shifted by the predetermined phase angle and is also referred to as the first phase-shifted transformation signal hereinafter, can be output at a first phase-shifter output 16, and the second phase-shifted transformation signal, which is phase-shifted by the predetermined phase angle and is also referred to as the second phase-shifted transformation signal, can be output at a second phase-shifter output 17.

The first phase-shifter output 16 is connected to the first input of an evaluation device 18, and the second phase-shifter output 17 is connected to the second input of the evaluation device 18. Using the evaluation device 18, an angle position signal can be generated as a function of the phase-shifted transformation signal that is present at the first and second phase-shifter output 16, 17, which signal shows the rotational position in which the magnet apparatus 2 is rotationally positioned about the axis of rotation 4, relative to the sensor apparatus 3. The angle position signal is determined in a computation device 42 of the evaluation device 18, by calculating the arctangent of the quotient of the first phase-shifted transformation signal present at the first phase-shifter output 16 and the second phase-shifted transformation signal present at the second phase-shifter output 17. The angle-position signal can be output at an angle position signal output 19 of the evaluation device 18.

In the case of the exemplary embodiments shown in FIGS. 2 and 3, the sensor apparatus 3 furthermore has a further signal path 20, on which a comparator 21 is arranged, which has a first comparator input that is connected to the measurement signal output 8 of the first magnetic field sensor 5. A second comparator input, not shown in any detail in the drawing, is connected to a threshold value transmitter, to compare the magnetic field measurement signal of the first magnetic field sensor 5 to a comparator threshold value signal. To output a digital comparison value signal 22, the comparator 21 has a comparator output 23 that is connected to a third input of the evaluation device 18. The comparator threshold value signal of the threshold value transmitter, in the case of a magnetic field sensor 5 having a non-differential measurement signal output 8, can lie at a potential, for example, that corresponds to the center of the supply voltage. In the case of a magnetic field sensor 5 having a differential measurement signal output 8, the comparator threshold value signal can correspond to the polarity of the measurement signal output 8. The flanks of the digital comparison value signal 22 can coincide with the zero transitions of the magnetic field measurement signal that is present at the measurement signal output of the first magnetic field sensor 5.

To detect a phase error, the evaluation device 18 has a phase position comparison element 24. In the case of the exemplary embodiment according to FIG. 3, the phase position comparison element 24 has a first phase position comparison element input 25 connected to the angle position signal output 19, a second phase position comparison element input 26 connected to the comparator output 23, and a phase position comparison element output 27 to output a phase position difference signal Δφ.

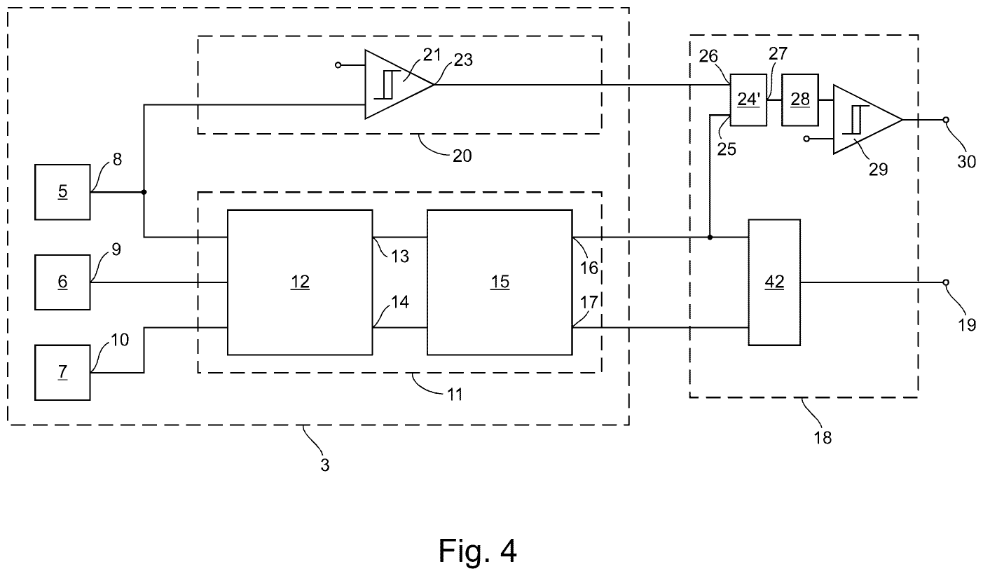

As can be seen in FIG. 4, the first phase position comparison element input 25 of the phase position comparison element 24′ can also be connected to a phase-shifter output 16, instead of to the angle position signal output 19. In the case of the exemplary embodiment shown in FIG. 2, the first phase position comparison element input 25 can also be connected to one of the output connectors 13, 14 of the transformation device, instead of to the angle position signal output 19.

To detect a change in the phase position difference signal Δφ, the evaluation device 18 has a phase position difference signal monitoring device 28, the input of which is connected to the phase position comparison element output 27 of the phase position comparison element 24. A signal that indicates a change in the phase position difference signal Δφ can be output at an output of the phase position difference signal monitoring device 28. This output is connected to a comparison device 29, by means of which the change in the phase position difference signal Δφ can be compared to a predetermined tolerance band. The result of the comparison can be output in the form of a digital error signal, at an output 30 of the comparison device 29.

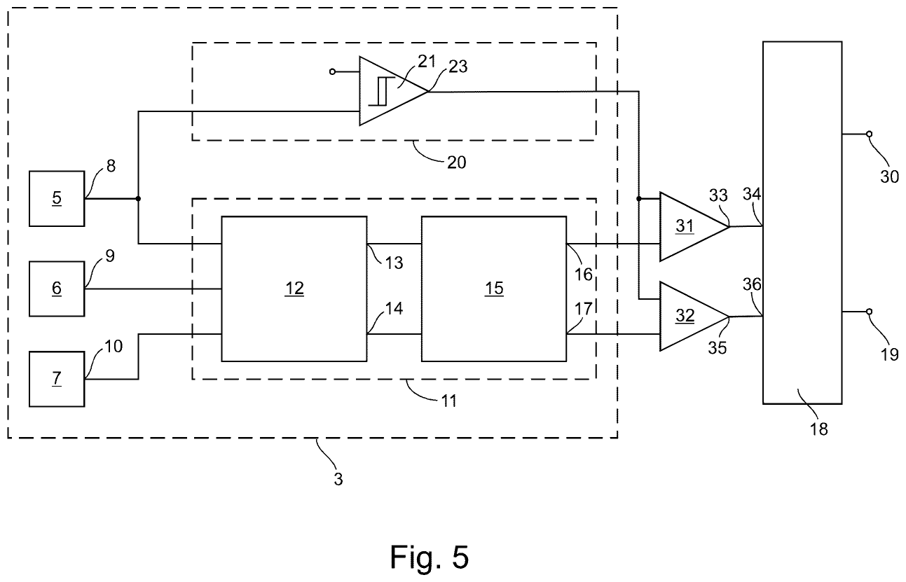

In the case of the exemplary embodiment shown in FIG. 5, the measurement apparatus 1 has two essentially identical modulation devices 31 and 32, each having two inputs. A first input of a first modulation device 31 is connected to the first phase-shifter output 16, and a second input of the first modulation device 31 is connected to the comparator output 23. The first modulation device 31 has a first differential modulation signal output 33, which [verb missing: is] connected to a first differential modulation signal input 34 of a first demodulation device of the evaluation device 18, not shown in any detail in the drawing.

A first input of a second modulation device 32 is connected to the second phase-shifter output 17, and a second input of the second modulation device 32 is connected to the comparator output 23. The second modulation device 32 has a second differential modulation signal output 35, which is connected to a second differential modulation signal input 36 of a second demodulation device of the evaluation device 18, not shown in any detail in the drawing.

In the demodulation devices, the phase-shifted first and second transformation signal as well as the digital comparison value signal 22 is restored from the modulated signals. Afterward, a first phase difference value is determined for the phase difference between the phase position of the angle position signal that is present at the angle position signal output 19 and the phase position of the digital comparison value signal 22, and compared with a tolerance range, so as to check whether the angle position signal correlates to the digital comparison value signal 22. An incorrect influence on the phase position can be caused, for example, by means of EMC interference acting on the transformation device 12 and/or the phase-shift device 15, and/or by random and/or systematic errors, for example in an integrated circuit of the sensor apparatus 3. If an incorrect influence on the phase position is present in one of the transformation signals (FIG. 2) and/or one of the phase-shifted transformation signals (FIG. 3), an error signal is generated and output at the output 30 of the evaluation device 18.

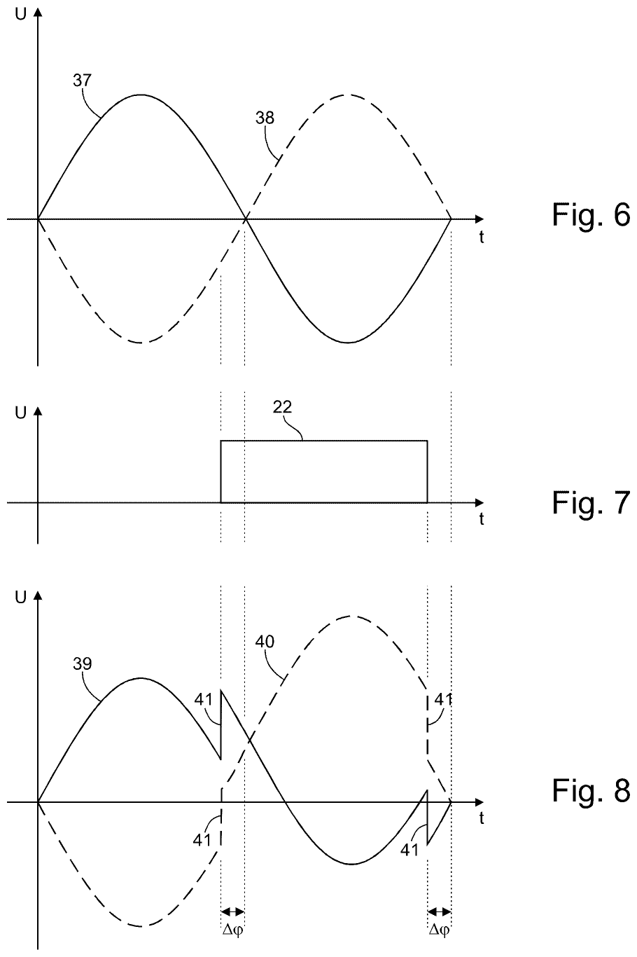

As can be seen in FIG. 6 to 8, the digital comparison value signal 22 (FIG. 7) is modulated by means of the first modulation device 31, as a direct component, onto each of the two differential partial signals 37, 38 (FIG. 6) of the first phase-shifted transformation signal, which is phase-shifted by the predetermined phase angle relative to the first transformation signal. As can be seen in FIG. 6, the partial signal 38 corresponds to the inverted partial signal 37. The first phase-shifted transformation signal corresponds to the difference of the partial signals 37, 38. The modulated first partial signal 39 and the modulated second partial signal 40 are shown in FIG. 8. These signals are output at the first modulation signal output 33. The sum of the modulated partial signals 39, 40 corresponds to the digital comparison value signal 22.

In a corresponding manner, the digital comparison value signal 22 is modulated, as a direct component, onto each of the two differential partial signals of the second phase-shifted transformation signal, by means of the second modulation device 32. The modulated first and second partial signals obtained in this manner are output at the second modulation signal output 35.

The evaluation device 18 calculates the angle position signal from the arctangent of the two phase-shifted transformation signals, for one thing, and carries out the phase error detection using the modulated partial signals 39, 40. The basis for this is the formation of the phase position difference signal Δφ, which represents the phase relationship between the output signal of the first signal path 11 and the output signal of the further signal path 20. The jumps or points of discontinuity contained in the modulated partial signals 39, 40 for this purpose can be detected in the evaluation device, using means that are generally known, such as low-pass filtering, for example.

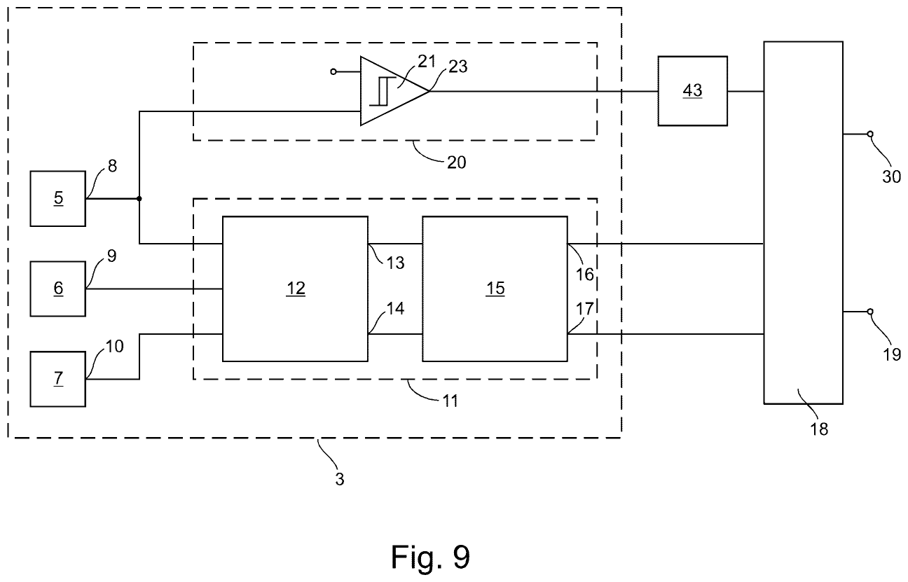

In FIG. 9, a further exemplary embodiment of the measurement apparatus 1 is shown, in which the operating current required for operation of the sensor apparatus 3 is taken from the evaluation device 18, and passed, by the latter, by way of an operating current modulation device 43, to the sensor apparatus 3. The operating current modulation device 43 has a control input that is connected to the comparator output 23 of the further signal path 20, so as to modulate the digital comparison value signal 22 onto the operating current of the sensor apparatus 3. The evaluation device 18 has an operating current demodulation device, not shown in any detail in the drawing, which is assigned to the operating current modulation device 42 and by means of which the evaluation device 18 is able to demodulate the digital comparison value signal 22 from the modulated operating current, so as to carry out error detection by means of forming and evaluating a phase difference. The phase shifter outputs 16, 17 of the first signal path 15 are directly connected to the evaluation device 18 in the case of this exemplary embodiment.

It should be noted to carry out the method of phase error detection, modulation of the digital comparison value signal 22 onto signals and lines that are present in any case is not absolutely necessary. On the contrary, this is a practical expansion of the invention, which saves additional lines/connections and correspondingly structured connectors, if applicable, on the level of the sensor apparatus 3. This is the case, for example, if the signal paths 11, 20 and the evaluation device 18 are structured to be spatially separated within the sensor apparatus 3, but connected by means of a cable harness. Vice versa, in the case of completely monolithic integration, also including the evaluation device 18, a direct connection according to FIG. 2 or 3 is more advantageous.

1. A measurement apparatus for determining an angle position signal, having a magnet apparatus and a sensor apparatus, which are mounted so as to rotate relative to one another, about a geometrical axis of rotation, wherein the sensor apparatus has a number of at least three magnetic field sensors that are arranged to be offset relative to one another, with reference to the axis of rotation, in terms of the angle of rotation, to generate magnetic field measurement signals that are phase-shifted relative to one another, wherein the magnetic field sensors have measurement signal outputs to output the magnetic field measurement signals, wherein the sensor apparatus has a first signal path in which a transformation device for transforming the at least three magnetic field measurement signals into a plurality of phase-shifted transformation signals is provided, which plurality is less than the number of the magnetic field sensors, wherein the measurement signal outputs of each magnetic field sensor are connected, in each instance, with an input of the transformation device, and the transformation device has an output connector for each transformation signal, in each instance, and wherein the output connectors are connected to an evaluation device, by means of which the angle position signal can be generated as a function of the transformation signals and output at an angle position signal output, wherein the sensor apparatus has at least one further signal path, in which a comparator is arranged, which is connected, for a comparison of the magnetic field measurement signal of one of the magnetic field sensors or a combination of the magnetic field measurement signals of multiple magnetic field sensors with a comparator threshold signal, to the measurement signal output of at least one magnetic field sensor, and has a comparator output for output of a digital comparison value signal, that the evaluation device has a phase position comparison element having a first and a second phase position comparison element input for detecting a phase error, that the first phase position comparison element input is connected to the first output connector of the transformation device or the angle position signal output, and the second phase position comparison element input is connected to the comparator output, and the phase position comparison element has a phase position comparison element output to output a phase position difference signal (Δφ).

2. The measurement apparatus according to claim 1, wherein the output connectors of the transformation device are indirectly connected to the evaluation device by way of a phase-shift device, that the phase-shift device has a phase-shifter output for each transformation signal, in each instance, to output a phase-shifted transformation signal that is shifted by a predetermined phase angle as compared with the transformation signal in question, and that the phase-shifter outputs are connected to the evaluation device to generate the angle position signal.

3. The measurement apparatus according to claim 2, wherein the evaluation device has a phase position difference signal monitoring device connected to the phase position comparison element output, to detect a change in the phase position difference signal (Δφ).

4. The measurement apparatus according to claim 3, wherein the phase position difference signal monitoring device has a comparison device for comparing the change in the phase position difference signal (Δφ) with a tolerance band.

5. The measurement apparatus according to claim 1, wherein the magnetic field sensors are structured as Hall sensors, TMR sensors, GMR sensors or AMR sensors.

6. The measurement apparatus according to claim 1, wherein the magnetic field sensors and the signal paths are implemented in a single cast IC housing, integrated in a monolithic or hybrid manner.

7. The measurement apparatus according to claim 1, wherein the magnetic field sensors and the signal paths are implemented on a support, in a discrete manner.

8. The measurement apparatus according to claim 1, wherein the measurement apparatus has at least one modulation device, which has a first input, directly or indirectly connected to one of the output connectors of the transformation device, by way of the phase-shift device, and a second input, connected to the comparator output of the further signal path, as well as a modulation signal output, and that the modulation signal output is connected to a demodulation device of the evaluation device assigned to the modulation device.

9. The measurement apparatus according to claim 1, wherein the measurement apparatus for the sensor apparatus has at least one operating current modulation device, to the input of which the comparator output of the further signal path is connected, and that the evaluation device is connected to an operating current demodulation device of the evaluation device assigned to the operating current modulation device.

10. A method for determining an angle position signal, having a magnet apparatus and a sensor apparatus, in which the magnet apparatus and the sensor apparatus are mounted so as to rotate about an axis of rotation relative to one another, wherein the sensor apparatus has a number of at least three magnetic field sensors arranged from one another with reference to the axis of rotation, in terms of the angle of rotation, to generate magnetic field measurement signals that are phase-shifted relative to one another, wherein the magnetic field measurement signals are transformed into a plurality of phase-shifted transformation signals, which plurality is less than the number of magnetic field sensors, and wherein the angle position signal is generated using the phase-shift signals obtained in this manner, wherein the magnetic field measurement signal of at least one magnetic field sensor or a combination of the magnetic field measurement signals of multiple magnetic field sensors is/are compared with a threshold value signal to generate a digital comparison value signal, and that in order to detect a phase error, the phase position of at least one transformation signal or the phase position of the angle position signal is compared to the phase position of the digital comparison value signal.

11. The method according to claim 10, wherein the magnetic field measurement signals are first transformed into the transformation signals that are phase-shifted relative to one another, that these are then shifted by a predetermined phase angle, in each instance, and that the angle position signal is generated as a function of the phase-shifted transformation signals obtained in this manner.

12. The method according to claim 10, wherein in order to generate a phase position difference signals (Δφ)
the difference between the phase position of at least one transformation signal and the phase position of the digital comparison value signal
or
the difference between the phase position of the angle position signal and the phase position of the digital comparison value signal
is formed, and the change in the phase position difference signal (Δφ) is detected.

13. The method according to claim 12, wherein the change in the phase position difference signal (Δφ) is compared to a tolerance band, and that an error signal is generated as a function of the result of this comparison.

14. The method according to claim 10, wherein the angle position signal is generated in an evaluation device, that the phase position of the digital comparison value signal is compared to the phase position of at least one transformation signal in the evaluation device, that the sensor apparatus is supplied with an operating current by way of the evaluation device, and that the digital comparison value signal is transmitted by the sensor apparatus to the evaluation device, by means of modulation of the operating current, and restored in the latter device by means of demodulation of the operating current.

15. The method according to claim 10, wherein the angle position signal is generated in an evaluation device, that the phase position of the digital comparison value signal is compared to the phase position of at least one transformation signal in the evaluation device, that the transformation signals are transmitted to the evaluation device as differential signals, and that the digital comparison value signal is transmitted to the evaluation device by means of modulation of the constant components of the transformation signals, and restored in the latter device by means of demodulation of the constant components.
